(19) United States
(12) Patent Application Publication
(10) Pub. No.: US 2007/0273266 A1
(43) Pub. Date: Nov. 29, 2007

(54) Planar light source device and method therefor

(75) Inventors: Yu-Heng Hsieh, Padeh City (TW); Chu-Chi Ting, Padeh City (TW); Hsin-Chia Ho, Padeh City (TW); Jau-Shiu Chen, Padeh City (TW); Wei-Yang Tseng, Padeh City (TW)

Correspondence Address: Venable LLP;Raymond J. Ho, 575 7th Street NW, Washington, DC, 20004-1601, US

(73) Assignee: CHUNGHWA PICTURE TUBES, LTD., Padeh City (TW)

(21) Appl. No.: 11/441,187

(22) Filed: May 26, 2006

(51) Int. Cl. H01J 63/04; H01J 1/62

(52) U.S. Cl. 313/485

(57) ABSTRACT

A planar light source device and a manufacturing method therefor are provided. The planar light source device includes a first substrate, a second substrate disposed under the first substrate and in parallel therewith at a specific distance therefrom and having a plurality of protrusions on an upper surface thereof or a plurality of recessions on a lower surface of the second substrate. The plurality of protrusions or recessions is formed by sandblasting or etching. Between the first and second substrates, a dielectric layer, a plurality of discharging spaces, a plurality of metal electrodes, a first phosphor layer, a second phosphor layer, a plurality of ribs and a reflective layer are provided and the reflective layer is formed on upper surfaces of the protrusions or lower surfaces of the recessions.

### BACKGROUND OF THE INVENTION

1. Field of the Invention

The present invention relates to a liquid crystal display (LCD) and particularly to a planar light source device and a manufacturing method therefor.

2. Descriptions of the Related Art

As compared to conventional cathode ray tubes (CRTs), liquid crystal displays (LCDs) provide advantages of slightness, compactness, and lower energy-consuming. For these reasons, the LCDs have been used as terminators in information systems and video units in replace of the CRTs. More recently, the LCDs have been capable of presenting wide viewing angles and preventing color tones thereof from shifting and thus picture quality thereof has been greatly improved. Therefore, the LCDs have been widely used in notebook computers and as display screens for desktop computers. Further, the LCDs have also been utilized as televisions.

Unlike the conventional CRT, the LCD is not provided with the ability of self-light-emitting and an annexed backlight unit is otherwise required in a practical use. The conventional backlight unit comprises a plurality of lamps as light source for picture displaying. Such lamp may typically be a fluorescent lamp. However, using the fluorescent lamp as light source must take a consideration of uniform lighting problem.

Referring to FIG. 1, a structure of a conventional planar light source is shown therein, comprising, from bottom to top, a second substrate 10, a plurality of metal electrodes 11, a dielectric ( or a reflective layer ) 12, a second phosphor layer 13, a plurality of ribs 14, a first phosphor layer 15, and a first substrate 16. Between the first and second substrates 16, 10, plasma is produced and molecules of stimulated gas (neon/xenon) therein are excited, giving off an ultraviolet ray. Then, the phosphors are excited by the ultraviolet ray and a visible light is emitted.

This plasma light source has a light emitting shape of triangle or a straight line, which is merely partially distributed. As can be seen in FIG. 1, there is no structure for diffusing light source. To achieve the uniform light emission purpose, a diffuser is required to be provided over the light source. However, the diffuser may block the light source at an extent up to 30% to 40%, causing a waste of the light source.

FIG. 2 shows a cross section view of another conventional gas discharge planar light source used as a backlight. The plasma planar light source device comprises a second substrate 20, a reflective layer 21, a dielectric layer 22, a discharging space 23, a gas (not shown), a plurality of metal electrodes 25, a second phosphor layer 26, a first phosphor layer 27, and a first substrate 29.

From the drawing, it may be seen that a visible light area 28 associated with the light emitting shape of a planar light source device is restricted over the discharging space 23 generated in the area having gas between the electrodes 25 while a dark area is presented over an area outside the area between the electrodes 25 and can not be reached by the light in the visible light area 28. To achieve a uniformly distributed light source, an additional diffuser is otherwise required.

In light of the above mentioned disadvantages, the present invention discloses a planar light source device and a method therefor. In present invention, a metal film having a particular pattern is formed on a second substrate of the planar light source by sandblasting or etching. The metal film is formed on the upper and lower surface of the second substrate so as to increase the reflective rate of the second substrate.

### SUMMARY OF THE INVENTION

It is, therefore, an object of the present invention to provide a planar light source device through which a light source may be diffused and thickness of a used diffuser may be reduced. Further, light leakage of the light source may be prevented and use efficiency of the light source may be increased.

It is another object of the present invention to provide a method for manufacturing planar light source device through which a light source may be diffused and thickness of a used diffuser may be reduced. Further, light leakage of the light source may be prevented and use efficiency of the light source may be increased.

To achieve the above object, this invention provides a planar light source device, which is used in an LCD. The planar light source device comprise a first substrate, a first phosphor layer coated on the inner side of the first substrate, a second substrate disposed under the first substrate and formed a plurality of protrusions on its upper surface, a dielectric layer covered on the inner side of the second substrate, a plurality of ribs disposed on the first and second substrates therein to form a plurality of discharging spaces and a gas filled in the discharging spaces, a second phosphor layer coated on the surface of the dielectric layer and side wall surface of the plurality of ribs, and a reflective layer formed on the surface of the plurality of protrusions.

The invention also provides another planer light source device, which is used in an LCD. The planar light source device comprise a first substrate, a first phosphor layer coated on the inner side of the first substrate, a second substrate disposed under the first substrate and formed a plurality of recessions on its lower surface, a dielectric layer covered on the inner side of the second substrate, a plurality of ribs disposed on the first and second substrates therein to form a plurality of discharging spaces, a second phosphor layer coated on the surface of the dielectric layer and side wall surfaces of the plurality of ribs, a gas filled in the discharging spaces, and a reflective layer formed on the plurality of recessions.

The present invention also discloses a manufacturing method for a planar light source device used in an LCD, comprising the steps of providing a first substrate, providing a second substrate, forming a plurality of discharging spaces in the first substrate and second substrate therein, forming a plurality of protrusions on an upper surface of the second substrate, coating a reflective layer on the plurality of protrusions, which has a first protrusion portion and a second protrusion portion connected to the first protrusion portion.

The present invention also discloses another manufacturing method for a planar light source device used in an LCD, comprising the steps of providing a first substrate, providing a second substrate, forming a plurality of discharging spaces in the first substrate and second substrate therein, forming a plurality of recessions on an lower surface of the second substrate, coating a reflective layer on the plurality of recessions, which has a first recession portion and a second recession portion connected to the first recession portion.

In this present invention for the planar light source device, a plurality of protrusions and recessions having a particular pattern is formed on the second substrate of the planar light source by sandblasting or etching, and then the reflective layer on the upper and lower surfaces of the second substrate is formed by vaporizing or sputtering Next, an ultraviolet ray is emitted by means of electrode discharging and then a visible light is emitted by the phosphors excited by the ultraviolet ray. Finally, through the reflective layer, the visible light is diffused and reflected to a dark area. As such, use efficient of a light source is increased.

The above and other objects and advantages of the present invention will be described in detail below taken from the preferred embodiments in conjunction with the annexed drawings.

### BRIEF DESCRIPTION OF THE DRAWINGS

FIG. 1 shows a schematic view of a structure of a conventional planar light source;

FIG. 2 shows a cross section view of another conventional gas discharge planar light source used as a backlight;

FIG. 3 shows a cross section view of a planar light source device according to a first embodiment of the present invention;

FIGS. 4A and 4B show schematically formation of a plurality of first protrusions and second protrusions in the planar light source device according to the first embodiment of the present invention;

FIG. 4C shows an enlarged view illustrating formation of the second protrusion according to the first embodiment of the present invention;

FIG. 5 shows a cross section view of a planar light source device according to a second embodiment of the present invention;

FIGS. 6A and 6B show schematically formation of a plurality of first recessions and second recessions in the planar light source device according to the second embodiment of the present invention;

FIG. 6C shows an enlarged view illustrating formation of the second recessions according to the second embodiment of the present invention;

FIG. 7 shows a flowchart of a manufacturing method for the planar light source device according to the first method embodiment of the present invention; and

FIG. 8 shows a flowchart of the manufacturing method for the planar light source device according to the second method embodiment of the present invention.

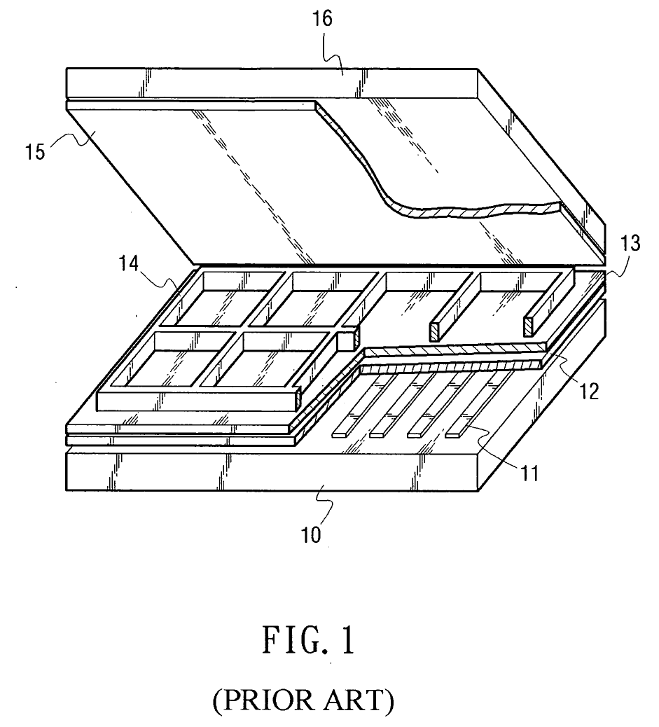

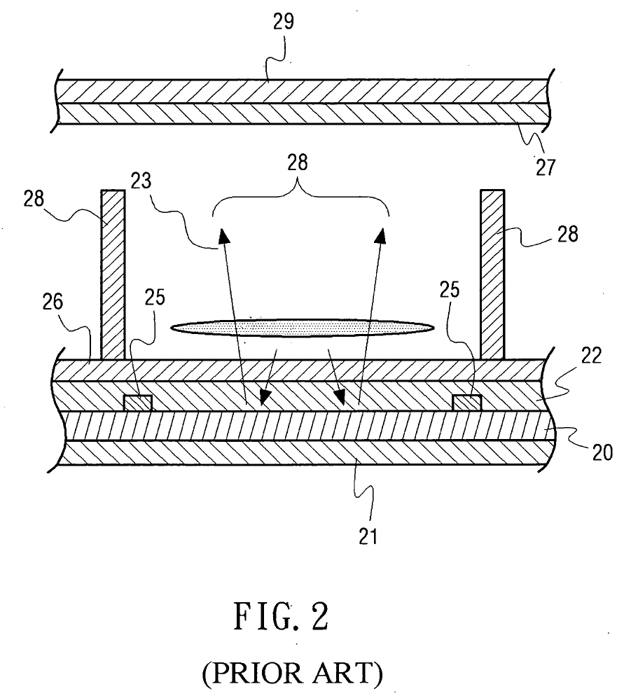

### DETAILED DESCRIPTION OF THE INVENTION

The present invention will be described below with reference to the accompanying drawings.

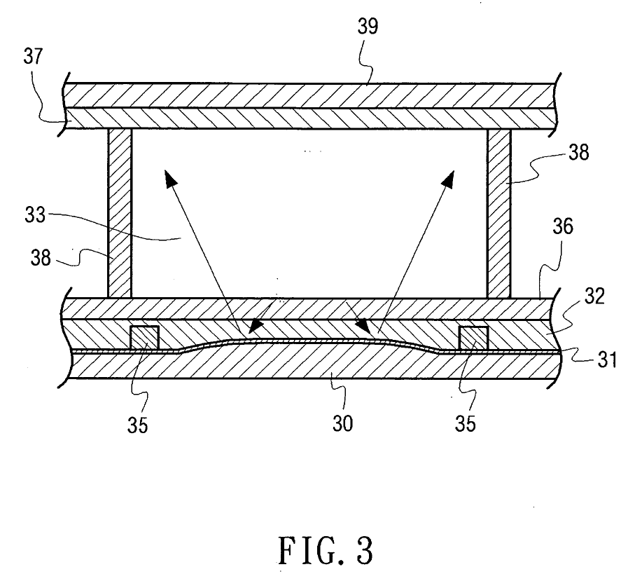

Referring to FIG. 3, a cross section view of a planar light source device according to a first embodiment of the present invention is shown therein, which is used in a backlight module of LCD. The planar light source device comprises a second substrate 30, a reflective layer 31, a dielectric layer 32, a plurality of discharging spaces 33, a gas (not shown) filled in the discharging spaces 33, a plurality of metal electrodes 35, a second phosphor layer 36, a first phosphor layer 37, a plurality of ribs 38, and a first substrate 39. As shown, when an emitted light reaches the reflective layer 31, the light may be uniformly reflected to achieve a purpose of light diffusion.

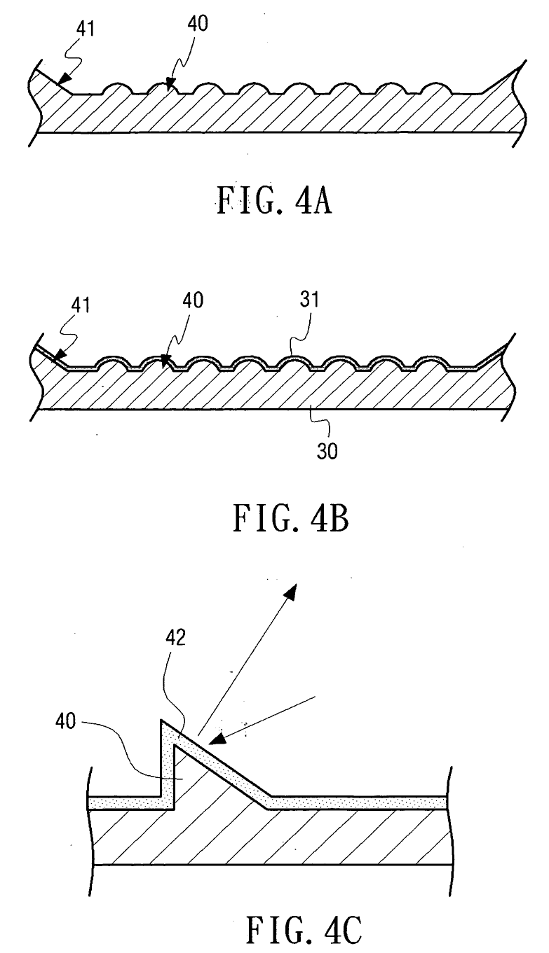

As shown in FIGS. 4A through 4C, a plurality of first protrusions 40 is formed on an upper surface of the second substrate 30 and second protrusions 41 are formed on edge of two sides of the upper surface of the second substrate 30, respectively, by sandblasting or etching. Then, the reflective layer 31, composed of aluminum (Al) or silver (Ag), is coated on the first and second protrusions 40, 41 at an altitude of approximate 1 μm by vaporizing or sputtering. The second protrusions 41 has a slanting surface 42, through which the light is reflected to a visible light area and thus the light may not leak, which can be seen in FIG. 4C.

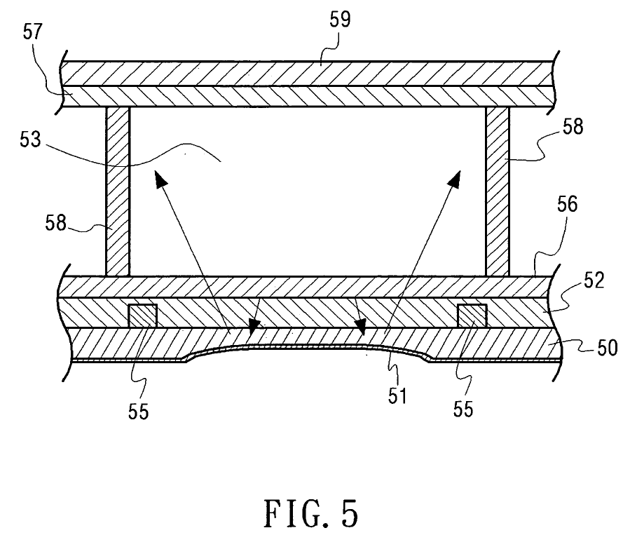

Referring to FIG. 5, the planar light source device according to a second embodiment of the present invention is depicted therein. The planar light source device comprises a second substrate 50, a reflective layer 51, a dielectric layer 52, a plurality of discharging spaces 53, a gas (not shown) filled in the discharging spaces 53, a plurality of metal electrodes 55, a second phosphor layer 56, a first phosphor layer 57, a plurality of ribs 58 and a first substrate 59.

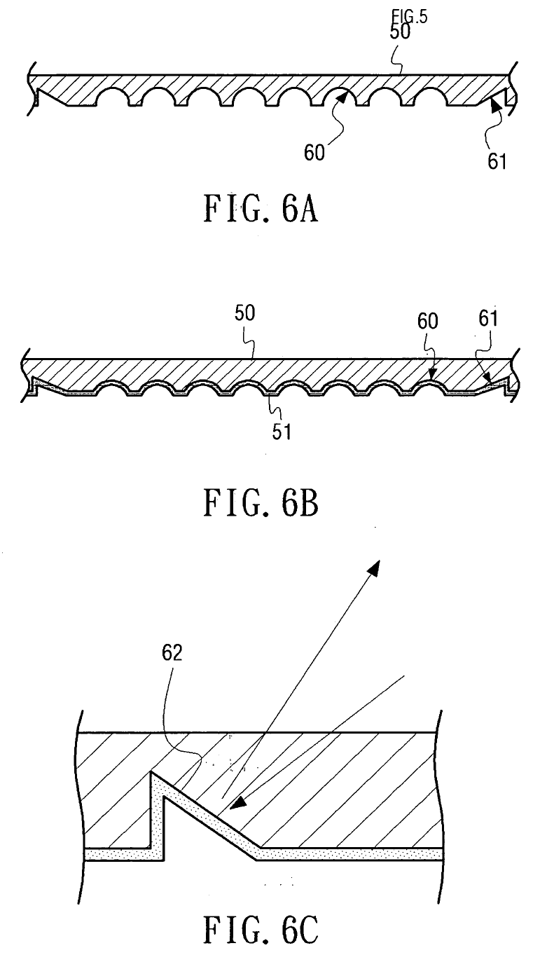

As shown, this embodiment is identical to the first embodiment except that the reflective layer 51 is formed on a lower surface of the second substrate 50 herein. In addition, as shown in FIGS. 6A through 6C, a plurality of first recessions 60 is formed on a lower surface of the second substrate 50 and second recessions 61 are formed on edge of two sides of the lower surface of the second substrate 50, respectively, by sandblasting or etching. Then, the reflective layer 51 is coated on the first and second recessions 60, 61 by vaporizing or sputtering so that the reflective layer 51 is provided with a particular pattern. When an emitted light reaches the reflective layer 51, the light may be reflected at a specific angle. As such, the light source diffusing purpose is achieved. Also, the reflective layer 51, composed of aluminum (Al) or silver (Ag), has an altitude of approximate 1 μm. In addition, the second recessions 61 have a slanting surface 62 shown in FIG. 6C, through which a light reflected to a visible light area may not leak.

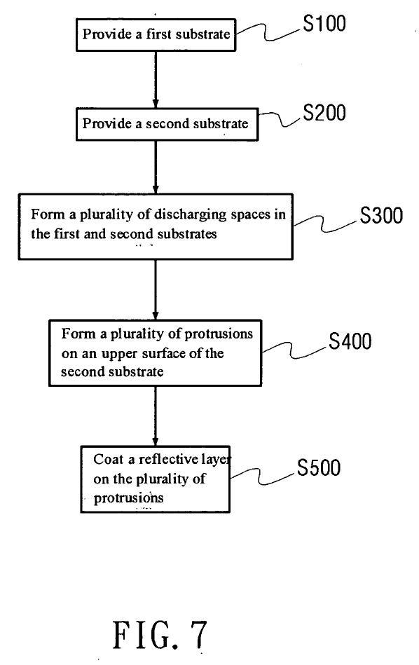

Referring to FIG. 7, a flowchart of a manufacturing method for the planar light source device according to the first embodiment of the present invention is shown therein. The method comprises the steps of providing a first substrate (S100), providing a second substrate (S200), forming a plurality of discharging spaces in the first and second substrates therein (S300), forming a plurality of protrusions on an upper surface of the second substrate (S400), coating a reflective layer on the plurality of protrusions, which has a first protrusion portion and a second protrusion portion connected to the first protrusion portion (S500).

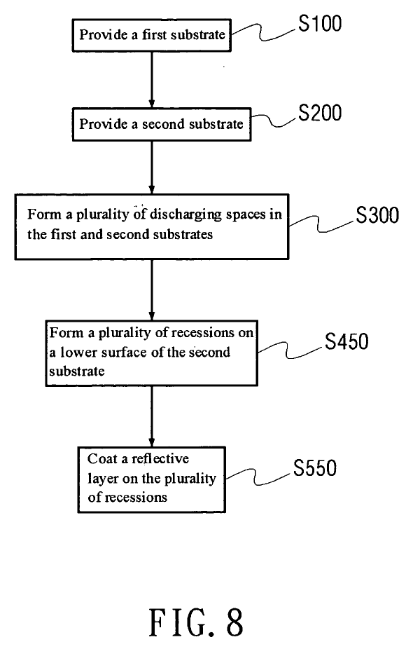

Referring to FIG. 8, a flowchart of a manufacturing method for the planar light source device according to the second embodiment of the present invention is shown therein. The method comprises the steps of providing a first substrate (S100), providing a second substrate (S200), forming a plurality of discharging spaces in the first and second substrates therein (S300), forming a plurality of recessions on a lower surface of the second substrate (S450), coating a reflective layer on the plurality of recessions, which has a first recession portion and a second recession portion connected to the first recession portion (S550).

In the method above described, the protrusions and recessions are formed by sandblasting or etching and the reflective layer is formed by vaporizing or sputtering. During the vaporizing or sputtering process performed, the reflective layer on the upper or lower surfaces is formed with a particular pattern so that the purposes of uniform light emitting and light leakage prevention may be achieved. As such, thickness of the used diffuser may be reduced and use efficiency of the light source may be increased.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

What is claimed is:

1. A planar light source device for liquid crystal display, comprising:
a first substrate;
a first phosphor layer coated on the inner side of said first substrate;
a second substrate disposed under said first substrate and having a plurality of protrusions formed on its upper surface;
a dielectric layer covered on the inner side of said second substrate;
a plurality of ribs disposed on said first and second substrates therein and forming a plurality of discharging spaces filled with a gas;
a second phosphor layer coated on the surface of said dielectric layer and the surface of the side wall of said plurality of ribs;
a reflective layer formed on the surface of said plurality of protrusions.

2. The planar light source device according to claim 1, wherein said dielectric layer further comprises a plurality of metal electrodes thereon.

3. The planar light source device according to claim 1, wherein said reflective layer is formed by coating.

4. The planar light source device according to claim 1, wherein said reflective layer is made of aluminum or silver.

5. The planar light source device according to claim 1, wherein said plurality of protrusions further comprise a plurality of first protrusions and a plurality of second protrusions.

6. The planar light source device according to claim 5, wherein each of said second plurality of protrusions have a slanting surface.

7. A planar light source device for liquid crystal display, comprising:
a first substrate;
a first phosphor layer coated on the inner side of said first substrate;
a second substrate disposed under said first substrate and having a plurality of recessions formed on its lower surface;
a dielectric layer covered on the inner side of said second substrate;
a plurality of ribs disposed on said first and second substrates therein and forming a plurality of discharging spaces;
a second phosphor layer coated on the surface of said dielectric layer and the surface of the side wall of said plurality of ribs;
a gas filled in said discharging spaces; and
a reflective layer formed on the surface of said plurality of recessions.

8. The planar light source device according to claim 7, wherein said dielectric layer further comprises a plurality of metal electrodes thereon.

9. The planar light source device according to claim 7, wherein said reflective layer is formed by coating.

10. The planar light source device according to claim 7, wherein said plurality of recessions further comprise a plurality of first recession portions and a plurality of second recession portions.

11. The planar light source device according to claim 7, wherein said reflective layer is made of aluminum or silver.

12. The planar light source device according to claim 10, wherein each of said second plurality of recessions have a slanting surface.

13. A manufacturing method for a planar light source device used in a liquid crystal display, comprising the steps of:
providing a first substrate;
providing a second substrate;
forming a plurality of discharging spaces in said first and second substrates therein;
forming a plurality of protrusions on an upper surface of said second substrate;
and
coating a reflective layer on said plurality of protrusions, which has a first protrusion portion and a second protrusion portion connected to said first protrusion portion.

14. The manufacturing method according to claim 13, wherein said reflective layer is made of alumni or silver.

15. The manufacturing method according to claim 13, wherein said reflective layer is formed by vaporizing or sputtering.

16. The manufacturing method according to claim 13, wherein each of said plurality of protrusions is formed by sandblasting or etching.

17. A manufacturing method for a planar light source device used in a liquid crystal display, comprising the steps of:
providing a first substrate;
providing a second substrate;
forming a plurality of discharging spaces in said first and second substrates therein;
forming a plurality of recessions on a lower surface of said second substrate; and
coating a reflective layer on the plurality of recessions, which has a first recession portion and a second recession portion connected to said first recession portion.

18. The manufacturing method according to claim 17, wherein said reflective layer is made of alumni or silver.

19. The manufacturing method according to claim 17, wherein the reflective layer is formed by vaporizing or sputtering.

20. The manufacturing method according to claim 17, wherein each of said plurality of recessions are formed by sandblasting or etching.
